(19) United States
(12) Patent Application Publication
(10) Pub. No.: US 2025/0173123 A1
(43) Pub. Date: May 29, 2025

(54) POLYNOMIAL ROOT SEARCH CIRCUITRY

(71) Applicant: XILINX, INC., San Jose, CA (US)

(72) Inventor: Alexandros VASILEIOU, Eidenburgh (GB)

(21) Appl. No.: 18/518,820

(22) Filed: Nov. 24, 2023

(51) Int. Cl. G06F 7/556; G06F 7/552

(52) U.S. Cl. CPC G06F 7/556; G06F 7/552

(57) ABSTRACT

Examples herein describe polynomial root search circuitry. The polynomial root search circuitry includes a search circuit configured to identify distinct roots of a first locator polynomial using parallel processing elements. A first subset of the parallel processing elements is configured to output terms of a second locator polynomial based on a first candidate root of the second locator polynomial. A second subset of the parallel processing elements is configured to output the terms of the second locator polynomial based on a second candidate root of the second locator polynomial.

### TECHNICAL FIELD

Examples of the present disclosure generally relate to wired communication systems (e.g., optical, electric, etc.), and more specifically, to polynomial root search circuitry.

### BACKGROUND

Wired communications systems transmit data (e.g., data frames) over a physical interface (e.g., electrical or optical) from a transmitter to a receiver. During transmission, the data is susceptible to various factors which can cause errors and distortions in the data such as noise, attenuation, reflection, etc. In order to ensure integrity of the data at the receiver, Reed-Solomon (RS) codes are often used to add redundancy to the data by the transmitter for transmission via the physical interface. The data and the redundancy can be represented as polynomials which are used by the receiver to compute a locator polynomial. Roots of the locator polynomial correspond to locations of errors in the data received at the receiver. By computing the roots and identifying the locations, the receiver can correct the errors in the data.

In order to compute the roots of a locator polynomial, a search circuit of the receiver evaluates all candidate roots of the locator polynomial by computing terms of the locator polynomial based on each of the candidate roots. For instance, each term of the locator polynomial is computed using a processing element of the search circuit. Because of silicon area limitations at the receiver, the search circuit includes a minimal number of the processing elements (typically one for each term of the locator polynomial). As a result, the candidate roots are evaluated one at a time in a serial search.

### SUMMARY

Polynomial root search circuitry is described in some embodiments. A search circuit of the polynomial root search circuitry is configured to identify distinct roots of a first locator polynomial using parallel processing circuits. In various embodiments, a first subset of the parallel processing circuits may be configured to output terms of a second locator polynomial based on a first candidate root of the second locator polynomial. A second subset of the parallel processing circuits can be configured to output the terms of the second locator polynomial based on a second candidate root of the second locator polynomial.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a processing circuit, according to an example.

FIG. 2 illustrates polynomial root search circuitry, according to an example.

FIG. 3 illustrates additional polynomial root search circuitry, according to an example.

FIG. 4 is a flow diagram depicting a method for identifying distinct roots of a polynomial, according to an example.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Wired communications systems transmit messages (data) from a transmitter to a receiver over a physical interface such as an optical/electrical interface. A variety of different factors can cause errors in the messages during transmission via the physical interface (e.g., noise, reflections, crosstalk, attenuation, etc.). While it may not be possible to prevent errors during the transmission, the errors can be corrected by the receiver using a forward error correction (FEC) system. For example, a Reed-Solomon (RS) code can be used at the transmitter to encode the messages as codewords. The codewords add redundancy to the messages which can be used to correct the errors in the messages. When a codeword that includes errors is received at the receiver, the FEC system can derive a locator polynomial based on properties of the RS code such that roots of the locator polynomial correspond to locations of the errors in the codeword.

In order to compute the roots, a search circuit of the FEC system evaluates all candidate roots of the locator polynomial by computing terms of the locator polynomial using each of the candidate roots. In some examples, each term of the locator polynomial is computed using a processing circuit of the search circuit. The search circuit includes a minimal number of the processing circuits (typically one for each term of the locator polynomial) because of silicon area limitations. As a result, the candidate roots are evaluated one at a time in sequential search which adds latency in the decoding process.

However, different variations of RS codes have corresponding locator polynomials with different numbers of terms. For example, IEEE 802.3 Clause 91 describes KP4 RS codes and KR4 RS codes. Examples herein describe polynomial root search circuitry that includes a search circuit (e.g., a Chien search circuit) configured to identify distinct roots of a first polynomial (e.g., a KP4 polynomial having a degree of 15) using parallel processing circuits.

In one or more embodiments, a first subset of the parallel processing circuits is configured to evaluate a first set of candidate roots of a second polynomial (e.g., a KR4 polynomial having a degree of 7). In some embodiments, the first set of the candidate roots includes a first half of the candidate roots for the second polynomial. A second subset of the parallel processing circuits is configured to evaluate a second set of the candidate roots of the second polynomial. For example, the second set of the candidate roots includes a second half of the candidate roots for the second polynomial.

In various embodiments, a combinational function includes a bit to distinguish between the first subset and the second subset. Silicon area occupied by a multiplexor using a bit to distinguish between the first subset and the second subset is insignificant in relation to the latency savings which is reduced by about half for identifying distinct roots of the second polynomial. Additionally, the described polynomial root search circuitry is not limited to examples including the KP4 polynomial and the KR4 polynomial. Rather, the described polynomial root search circuitry is extendable to any scenario in which available hardware for decoding a relatively strong code in series can be leveraged for decoding a relatively weak code in parallel.

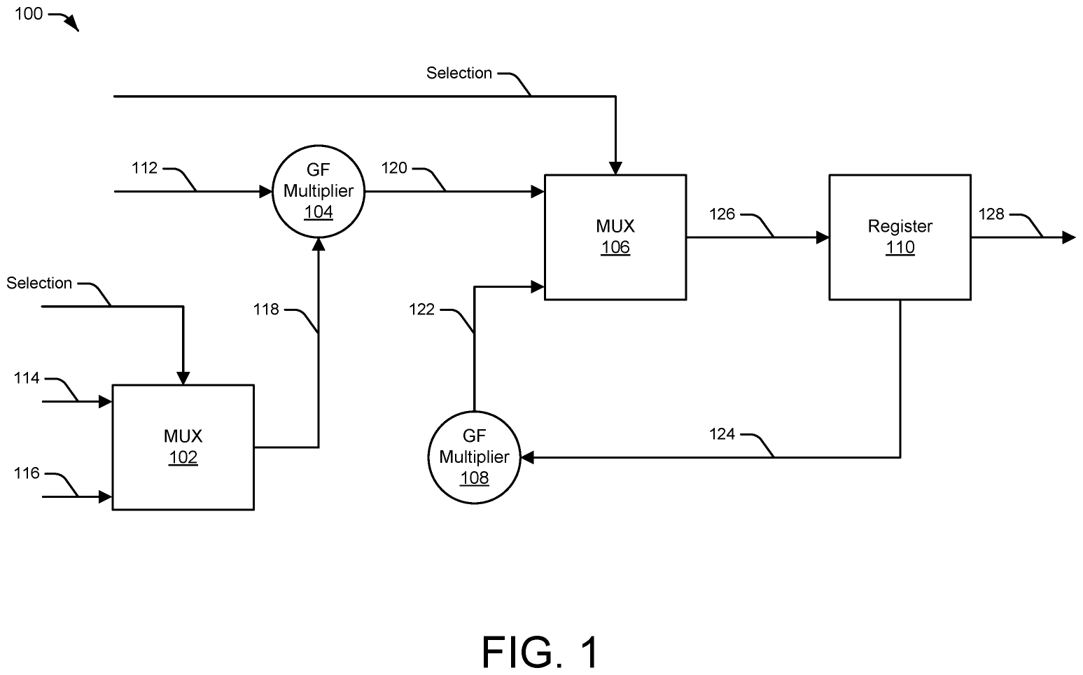

FIG. 1 illustrates a processing circuit 100, according to an example. In one or more embodiments, the processing circuit 100 is included in a receiver of a wired communications system. The wired communications system transmits data over a physical interface (electrical or optical) from a transmitter to the receiver. Before the data is received at the receiver, it is possible for the data to be modified or distorted such that the data includes errors. For example, during transmission via the physical interface, the data is susceptible to noise, attenuation, reflection, and so forth.

In some embodiments, in order to identify and correct any errors included in the data received by the receiver, the wired communications system can include a forward error correction (FEC) system using Reed-Solomon (RS) codes. In these embodiments, the data to be transmitted by the transmitter is referred to as a message, and the transmitter encodes the message as a codeword using the RS codes. For instance, the codeword is longer than the message and includes the original data to be transmitted and additional redundancy information.

A particular length of the codeword and/or the message can vary based on characteristics of the RS codes which may be designed for specific applications, certain correction capabilities, various latency requirements, etc. For example, IEEE 802.3 Clause 91 describes two different variations of RS codes. The first variation is KP4 which has a codeword length of N=544 symbols and a message length of K=514 symbols. The second variation is KR4 which has a codeword length of N=528 symbols and a message length of K=514 symbols.

In an example, the receiver receives the codeword which can include errors from being transmitted over the physical interface. In this example, the receiver computes syndromes based on the codeword which are used to determine a presence of errors and locations of the errors. In various embodiments, the receiver iterates through the syndromes in order to compute a locator polynomial such that the roots of the locator polynomial correspond to the locations of the errors. For instance, characteristics of the locator polynomial can vary based on an RS code utilized to encode the codeword. By way of example, a locator polynomial for the KP4 variation has a degree of 15 while a locator polynomial for the KR4 variation has a degree of 7.

In some examples, the locator polynomial is representable as:

$$L ( x ) = {\sum }_{i = 0}^{t} {L}_{i} \cdot {x}^{i}$$

where: L(x) denotes the locator polynomial; Lᵢ is a coefficient of the locator polynomial; and t defines a degree of the locator polynomial (e.g., t is 15 for the KP4 variation and 7 for the KR4 variation).

In order to identify the roots of the locator polynomial, the receiver utilizes a search circuit (e.g., a Chien search circuit) that includes the processing circuit 100. In one or more embodiments, the processing circuit 100 is capable of computing a value of one term Lᵢ·xⁱ of the locator polynomial L(x) at a candidate root x_{cr} for the locator polynomial. For instance, in order to evaluate one candidate root per clock cycle, the search circuit includes a processing circuit 100 for each term of the locator polynomial (e.g., the search circuit includes 16 processing circuits 100 for the KP4 variation and the search circuit includes 8 processing circuits 100 for the KR4 variation). If the sum of values of every term of the locator polynomial L(x) computed at the candidate root x_{cr} is equal to zero, then the candidate root is identified as a distinct root of the locator polynomial. Once all of the distinct roots of the locator polynomial are identified, the FEC system is capable of correcting errors included in the data received by the receiver.

Candidate roots are evaluated in a range of α⁴⁸⁰ to α¹⁰²³ because the KP4 variation code is generally a (1023, 993) shortened code where a first 480 symbols are zero. For example, as a result of silicon area limitations, the search circuit for the KP4 variation is limited to including 16 processing circuits 100. However, since the search circuit for the KR4 variation includes 8 processing circuits 100, the processing circuit 100 could be used in both the search circuit for the KP4 variation and the search circuit for the KR4 variation.

In the illustrated example, the processing circuit 100 includes a multiplexor 102, a Galois field multiplier 104, a multiplexor 106, a Galois field multiplier 108, and a register 110. Although the multiplexors 102, 106, the Galois field multipliers 104, 108, and the register 110 are illustrated as separate elements in FIG. 1, it is to be appreciated that in various embodiments, any of these elements can be combined with one or more other elements. It is to be further appreciated that the multiplexors 102, 106, the Galois field multipliers 104, 108, and the register 110 can each be implemented in hardware, software, or a combination of hardware and software.

In one or more embodiments, the processing circuit 100 computes a value of a term of the locator polynomial L(x) at the candidate root x_{cr} by receiving a coefficient Lᵢ 112 of the term at the Galois field multiplier 104. The coefficient Lᵢ 112 may be generated, for example, by reading syndromes and implementing a Berlekamp-Massey algorithm (BMA). Notably, the BMA can be the original BMA or a variation (e.g., RiBM, TiBM, etc.). In some examples, the coefficient Lᵢ 112 is a 10 bit coefficient. In one or more examples, a bank of 160 registers may store the coefficient Lᵢ 112 and 15 additional 10 bit coefficients. However, the coefficient Lᵢ 112 and the additional coefficients are not necessarily stored in memory as these coefficients are only utilized in a first step of a root search. In various examples, the coefficient Lᵢ 112 is less than 10 bits or greater than 10 bits.

In some embodiments, the multiplexor 102 receives a first input 114 and/or a second input 116 and outputs a Galois field symbol 118 based on the first input 114 and/or the second input 116. In various examples, the first input 114 may correspond to the KP4 variation and the second input 116 can correspond to the KR4 variation. For example, silicon area consumed by the multiplexor 102 is negligible compared to latency savings (e.g., for the KR4 variation).

In one or more embodiments, the first input 114 may be represented as:

(α^{480+j})ⁱ

where: 0≤i≤t; 0≤j≤(P−1); and P represents a degree of parallelism (e.g., a number of candidate roots that can be processed simultaneously by the receiver).

In various embodiments, the second input 116 can be represented as:

$${( {α}^{480 + j + N / 2} )}^{i}$$

where: N is a codeword length (e.g., 544 symbols for the KP4 variation and 528 symbols for the KR4 variation).

In some examples, the Galois field multiplier 104 can be used for both KP4 and/or KR4 variations. In these examples, the Galois field multiplier 104 multiplies an input coefficient Lᵢ 112 with either the first input 114 or the second input 116, depending on the type of variation.

In various embodiments, the multiplexor 106 receives an input 120 from the Galois field multiplier 104 and an input 122 from the Galois field multiplier 108 based on feedback 124. On the first clock cycle of this iterative process, an output 126 gets the input 120 and on all other clock cycles, the output 126 gets the input 122. In one or more embodiments, the term value 128 is summed by a summation circuit with computed values for the other terms of the locator polynomial L(x) to determine whether the candidate root x_{cr} is a root of the locator polynomial L(x). In an example, the summation circuit is configured to sum outputs of the processing circuits 100. For example, if the sum of the terms is zero, then the candidate root x_{cr} is a root of the locator polynomial L(x).

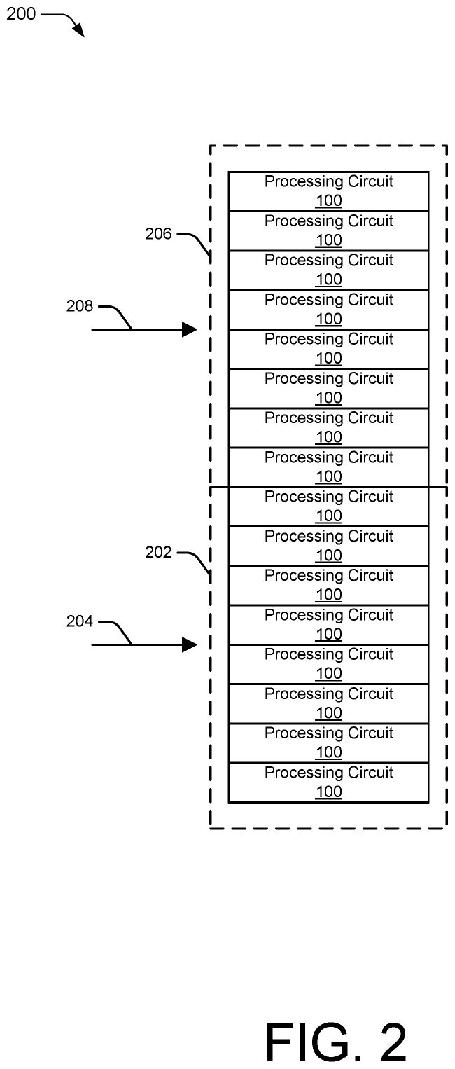

FIG. 2 illustrates polynomial root search circuitry 200, according to an example. In various embodiments, the polynomial root search circuitry 200 includes 16 parallel processing circuits 100 and each of the parallel processing circuits 100 is capable of computing a value of a term of a polynomial. In some examples, the polynomial root search circuitry 200 can evaluate a candidate root of a polynomial for the KP4 variation because the KP4 polynomial has the degree of 15. In these examples, the polynomial root search circuitry 200 may evaluate one candidate root for the KP4 polynomial each clock cycle.

In one or more embodiments, since the parallel processing circuits 100 can be used for both the KP4 variation and the KR4 variation, a first subset 202 of the parallel processing circuits 100 can be used to evaluate a first candidate root 204 for a polynomial of the KR4 variation and a second subset 206 of the parallel processing circuits 100 may be used to evaluate a second candidate root 208 for the KR4 polynomial. In various examples, by utilizing the multiplexor 102, the polynomial root search circuitry 200 can evaluate two candidate roots for the KR4 polynomial each clock cycle. In an example, latency of the KP4 variation may be represented as:

$$( 528 / P + 3 )$$

where: P represents a parallelization factor of a Chien search circuit; and +3 represents pipelined stages for summing polynomial terms and checking whether the summation is zero or not.

However, in some examples, by utilizing the first subset 202 to evaluate the first candidate root 204 and the second subset 206 to evaluate the second candidate root 208, latency of the KR4 variation may be represented as:

$$( 528 / P / 2 + 3 )$$

As noted above, the silicon area consumed by the multiplexor 102 is negligible compared to the corresponding latency savings for the KR4 variation.

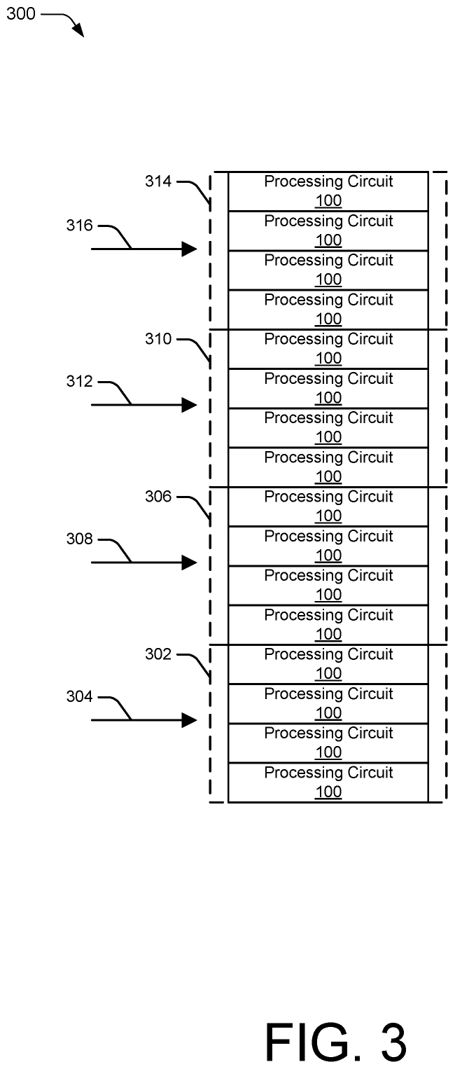

FIG. 3 illustrates additional polynomial root search circuitry 300, according to an example. In various embodiments, the additional polynomial root search circuitry 300 includes parallel processing circuits 100. For instance, the additional polynomial root search circuitry 300 includes a sufficient number of the processing circuits 100 in parallel to evaluate candidate roots of a polynomial for a relatively strong code such as the KP4 variation. As shown in FIG. 3, a first subset 302 of the parallel processing circuits 100 can evaluate a first candidate root 304 of a polynomial for a relatively weak code. As further shown, a second subset 306 of the parallel processing circuits 100 may evaluate a second candidate root 308 of the polynomial for the relatively weak code. For example, a third subset 310 of the parallel processing circuits 100 can evaluate a third candidate root 312 of the polynomial for the relatively weak code and a fourth subset 314 of the parallel processing circuits 100 may evaluate a fourth candidate root 316 of the polynomial for the relatively weak code. In various embodiments, the described systems and techniques can be extended to any scenario in which the relatively weak code can benefit from the parallel processing circuits 100 which are implemented to evaluate candidate roots of the polynomial for the relatively strong code.

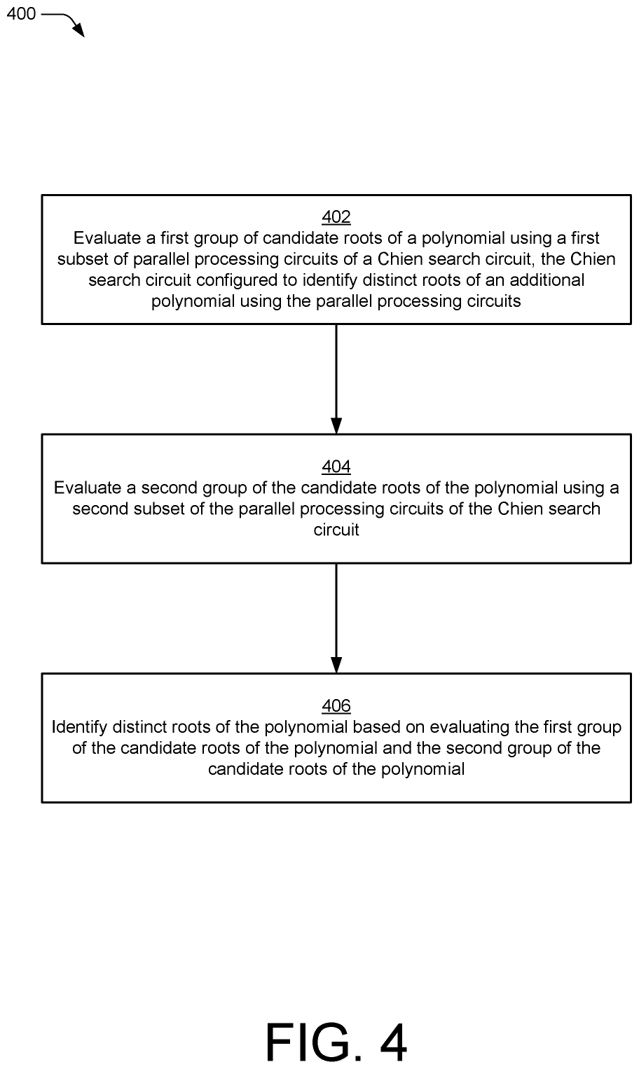

FIG. 4 is a flow diagram depicting a method 400 for identifying distinct roots of a polynomial, according to an example. At 402, a first group of candidate roots of a polynomial is evaluated using a first subset of parallel processing circuits of a Chien search circuit, the Chien search circuit is configured to identify distinct roots of an additional polynomial using the parallel processing circuits. For example, the first group of the candidate roots of the KR4 polynomial includes the first candidate root 204 that is evaluated using the first subset 202 of the parallel processing circuits 100. In an example, the Chien search circuit is configured to identify distinct roots of the KP4 polynomial using the parallel processing circuits 100. In one or more examples, the Chien search circuit is configured to identify the distinct roots of the additional polynomial over a Galois field as part of a FEC system using RS codes.

At 404, a second group of the candidate roots of the polynomial is evaluated using a second subset of the parallel processing circuits of the Chien search circuit. In some examples, the second group of the candidate roots of the KR4 polynomial includes the second candidate root 208 that is evaluated using the second subset 206 of the parallel processing circuits 100. For example, the first subset 202 outputs terms of the KR4 polynomial computed at the first candidate root 204 and the second subset 206 outputs terms of the KR4 polynomial computed at the second candidate root 208 in parallel. In some examples, at least one summation circuit sums the terms of the KR4 polynomial output by the first subset 202 and at least one summation circuit sums the terms of the KR4 polynomial output by the second subset 206.

At 406, distinct roots of the polynomial are identified based on evaluating the first group of the candidate roots of the polynomial and the second group of the candidate roots of the polynomial. In various examples, distinct roots of the KR4 polynomial are identified by the first subset 202 and the second subset 206. In some examples, the first subset 202 is a first half of the parallel processing circuits 100 included in the Chien search circuit and the second subset 206 is a second half of the parallel processing circuits 100 included in the Chien search circuit. In other examples, the first and second subsets 202, 206 include less than half of the parallel processing circuits included in the Chien search circuit. In one or more examples, the Chien search circuit includes the third subset 310 of the parallel processing circuits 100 that evaluates a third group of the candidate roots of the polynomial, and the third group of the candidate roots includes the third candidate root 312. In some examples, the Chien search circuit includes the fourth subset 314 of the parallel processing circuits 100 that evaluates a fourth group of the candidate roots of the polynomial, and the fourth group of the candidate roots includes the fourth candidate root 316.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

While the foregoing is directed to specific examples, other and further examples may be devised without departing from the basic scope thereof, and the scope thereof is determined by the claims that follow.

What is claimed is:

1. Polynomial root search circuitry comprising:
a search circuit configured to identify distinct roots of a first locator polynomial using parallel processing circuits;
a first subset of the parallel processing circuits configured to output terms of a second locator polynomial based on a first candidate root of the second locator polynomial; and
a second subset of the parallel processing circuits configured to output the terms of the second locator polynomial based on a second candidate root of the second locator polynomial.

2. The polynomial root search circuitry of claim 1, wherein the search circuit is a Chien search circuit.

3. The polynomial root search circuitry of claim 1, wherein the first locator polynomial has a degree of 15.

4. The polynomial root search circuitry of claim 1, wherein the second locator polynomial has a degree of 7.

5. The polynomial root search circuitry of claim 1, wherein the first subset of the parallel processing circuits and the second subset of the parallel processing circuits are configured to identify distinct roots of the second locator polynomial.

6. The polynomial root search circuitry of claim 1, further comprising at least one summation circuit configured to sum outputs of the parallel processing circuits.

7. The polynomial root search circuitry of claim 1, wherein the distinct roots of the first locator polynomial are identified over a Galois field.

8. The polynomial root search circuitry of claim 1, wherein the terms of the second locator polynomial based on the first candidate root of the second locator polynomial and the terms of the second locator polynomial based on the second candidate root of the second locator polynomial are output in parallel.

9. The polynomial root search circuitry of claim 1, wherein the second locator polynomial is a KR4 polynomial and the first locator polynomial is a KP4 polynomial.

10. Circuitry comprising:
a Chien search circuit configured to identify distinct roots of a first polynomial using parallel processing circuits;
a first subset of the parallel processing circuits configured to output first values of terms of a second polynomial based on a first candidate root of the second polynomial; and
a second subset of the parallel processing circuits configured to output second values of the terms of the second polynomial based on a second candidate root of the second polynomial.

11. The circuitry of claim 10, further comprising at least one summation circuit configured to sum outputs of the parallel processing circuits.

12. The circuitry of claim 10, wherein the first subset of the parallel processing circuits and the second subset of the parallel processing circuits are configured to identify distinct roots of the second polynomial.

13. The circuitry of claim 10, wherein the first polynomial has a degree of 15.

14. The circuitry of claim 10, wherein the second polynomial has a degree of 7.

15. The circuitry of claim 11, wherein the first subset of the parallel processing circuits is a first half of the parallel processing circuits and the second subset of the parallel processing circuits is a second half of the parallel processing circuits.

16. A processing circuit comprising:
a first multiplexor configured to output a value of a term of a locator polynomial based on a candidate root of the locator polynomial;
a Galois field multiplier configured to output an input to the first multiplexor based on an input coefficient and a Galois field symbol; and
a second multiplexor configured to output the Galois field symbol based on whether the locator polynomial has a first degree or a second degree.

17. The processing circuit of claim 16, further comprising a Chien search circuit configured to identify distinct roots of the locator polynomial.

18. The processing circuit of claim 16, wherein the locator polynomial is at least one of a KR4 polynomial or a KP4 polynomial.

19. The processing circuit of claim 16, wherein the first degree is 15.

20. The processing circuit of claim 19, wherein the second degree is 7.
